(19) United States
(12) Patent Application Publication
(10) Pub. No.: US 2026/0053319 A1
(43) Pub. Date: Feb. 26, 2026

(54) INTELLIGENT LASER GROUND SCRUBBER

(71) Applicant: Luoyang SFX Laser Intelligent Equipment Co., Ltd., Luoyang (CN)

(72) Inventors: Xiangyang DING, Luoyang (CN); Shaobo ZHANG, Luoyang (CN); Shaohui CAO, Luoyang (CN); Zhenpeng XIE, Luoyang (CN)

(21) Appl. No.: 18/812,450

(22) Filed: Aug. 22, 2024

(51) Int. Cl. A47L 11/28; B23K 26/142; B23K 26/352

(52) U.S. Cl. CPC A47L 11/28; B23K 26/142; B23K 26/352; A47L 2201/04

(57) ABSTRACT

An intelligent laser ground scrubber is provided. A laser cleaning device cleans dirt on materials to be cleaned or on ground. A laser lens surface anti-dust device prevents smoke dust particles from adhering to the surface of the lens of the laser cleaning device and prevents the lens from overheating and burning. A dust collection and smoke removal device discharges cleaned smoke dust impurities to a multistage activated carbon filter screen with an adsorption function along an air flue. A SLAM intelligent algorithm control system and a visual device with sensor are used for positioning and mapping and sending out control signals to drive a walking device to move and avoid obstacles. A power supply is connected with the laser cleaning device, the dust collection and smoke removal device, the walking device, a drive controller, the visual device with sensor and the SLAM intelligent algorithm control system, respectively.

### TECHNICAL FIELD

The present disclosure relates to the field of cleaning machinery, in particular to an intelligent laser ground scrubber.

### BACKGROUND

The mobility of personnel is high in indoor and outdoor squares and large-scale activity places. Especially on the stone ground, various complex dirt and stains are easy to adhere. In the cleaning method of the existing ground scrubbers on the market, the ground scrubber is manually pushed or driven to walk and clean the ground, and the cleaning rate is high on conventional ground. However, since the degrees of pollution on complex ground are different, traditional mechanical hard brushes and dirt collectors only play a role in cleaning the superficial dirt instead of removing the deep-layer dirt. Through chemical cleaning, the cleaning quality can be ensured, but the environment is polluted. If the pollution problem needs to be further dealt with, the cost of waste disposal will be further increased.

### SUMMARY

The purpose of the present disclosure is to provide an intelligent laser ground scrubber. With high-energy laser beams focused on the ground, deep-layer dirt may be removed from complex ground, improving the ground cleaning efficiency, and reducing the cleaning cost of the complex ground.

In order to achieve the purpose, the present disclosure provides the following solutions.

An intelligent laser ground scrubber includes a laser cleaning device, a laser lens surface anti-dust device, a dust collection and smoke removal device, a walking device, a drive controller, a visual device with sensor, a SLAM (Simultaneous Localization and Mapping) intelligent algorithm control system and a power supply.

The laser cleaning device is configured for cleaning dirt on materials to be cleaned or on ground. The dirt is separated from surfaces of the materials to be cleaned by high-energy laser beams generated by the laser cleaning device.

The laser lens surface anti-dust device is connected with the laser cleaning device. The laser lens surface anti-dust device is configured for preventing smoke dust particles from adhering to the lens surface of the laser cleaning device and preventing the lens from overheating and burning.

The dust collection and smoke removal device is connected with the laser cleaning device. The dust collection and smoke removal device is configured for discharging cleaned smoke dust impurities to a multistage activated carbon filter screen with an adsorption function along an air flue.

The SLAM intelligent algorithm control system and the visual device with sensor are arranged on the walking device. The SLAM intelligent algorithm control system and the visual device with sensor are configured for positioning and mapping and sending out control signals to drive the walking device to move and avoid obstacles.

The power supply is connected with the laser cleaning device, the dust collection and smoke removal device, the walking device, the drive controller, the visual device with sensor and the SLAM intelligent algorithm control system, respectively. The power supply supplies power for the laser cleaning device, the dust collection and smoke removal device, the walking device, the drive controller, the visual device with sensor and the SLAM intelligent algorithm control system, respectively.

The laser cleaning device, the laser lens surface anti-dust device, the dust collection and smoke removal device, the drive controller and the power supply are mounted inside the walking device.

The visual device with sensor is mounted outside the walking device.

Optionally, the laser cleaning device includes a laser generator, a mechanical screw, a sliding rail, a cleaning head and a head galvanometer control system.

Optionally, the laser lens surface anti-dust device is connected with the laser lens of the laser cleaning device.

Optionally, the dust collection and smoke removal device includes an axial flow fan, a wide-width dust suction port, and a three-stage purification filter screen.

Optionally, the walking device and the drive controller include a drive controller, a first brushless motor, a second brushless motor, a reduction gearbox, large-sized front drive wheels, rear universal wheels and drive wheel clutches.

Optionally, the visual device with sensor includes an ultrasonic sensor, a crash sensor and a visual camera.

Optionally, the SLAM intelligent algorithm control system is connected with the visual device with sensor and the drive controller, respectively.

Optionally, power supply modes of the power supply include a wired direct electrification mode, a rechargeable battery mode or a self-power mode.

According to the specific embodiments provided in the present disclosure, the present disclosure has the following technical effects.

In most of existing laser cleaning methods, mechanical equipment is manually operated to clean dirt, but the present disclosure realizes the combination of laser cleaning equipment and an automatic ground scrubbing device for the first time. The walking device is driven by double motors, flexible in straight walking or spin turn, stable in speed, and supports a continuously viable speed regulation. The axial flow fan of the dust collection and smoke removal device is used for a two-stage dust collection and a three-stage purification filter screen. In the three-stage purification filter screen, a first-stage filter screen is used for filtering large-volume impurities, a second-stage metal filter screen is used for filtering oily substances, and a third-stage activated carbon filter screen is used for adsorbing unpleasant odor. The cleaning head of the laser cleaning device is detachable, and the head is fixed by the fixed buckle, so that not only the cleaning along with the machine can be realized, but also the hand-held cleaning in corner areas can be realized by detaching the cleaning head. Moreover, through the integrated modularization of the head, buckles can be added to achieve multi-head fixation according to needs. Meanwhile, the control system can realize the coordinated control of multi-galvanometer heads, and parameters can be uniformly modified through a single screen, and the height of a fixing screw of the cleaning head is automatically adjusted during walking to ensure an appropriate focal length. The SLAM (Simultaneous Localization and Mapping) intelligent algorithm control system is cooperated with the visual device with sensor for building a map and positioning the machine, and the path can be planned to realize automatic cleaning after the first cleaning is completed. During the laser cleaning process, images on cleaning effects may be shot by the visual camera to judge the cleaning quality. The walking speed and laser cleaning parameters are adjusted according to cleaning effect.

The laser cleaning device is equipped with a laser cleaning head, and the cleaning quality is higher than that of conventional mechanical cleaning. The two-stage dust collection and smoke removal device is matched with the three-stage purification filter screen for synchronous cleaning and synchronous processing to achieve a green and environmentally-friendly cleaning process. The power supply is equipped, so that the endurance of operation is ensured. The visual device with sensor is combined with the SLAM intelligent algorithm control system, so that the machine can build map information. Not only a manual operation of equipment can be selected for cleaning, but also an automatic mode can be switched to automatically find stains for cleaning according to a planning path of the set area. The cleaning parameters are automatically adjusted according to the comparison of visually shot cleaning effects, so that fixed-time and fixed-point cleaning tasks can be efficiently completed, thus saving the human resources. In the present disclosure, deep-layer dirt can be removed on complex ground, and the ground scrubber has the advantages of high cleaning efficiency, less damage to the ground, no chemical residues and the like.

### BRIEF DESCRIPTION OF THE DRAWINGS

To more clearly illustrate embodiments of the present disclosure or the technical solution of the prior art, the following will briefly introduce the accompanying drawings used in the embodiments. The accompanying drawings in the following description show merely some embodiments of the present disclosure, and for those skilled in the art, other drawings maybe still derived in light of these accompanying drawings without creative labor.

FIG. 1 is a structural schematic diagram of an intelligent laser ground scrubber provided by the embodiment of the present disclosure.

FIG. 2 is a side view of an intelligent laser ground scrubber provided by the embodiment of the present disclosure.

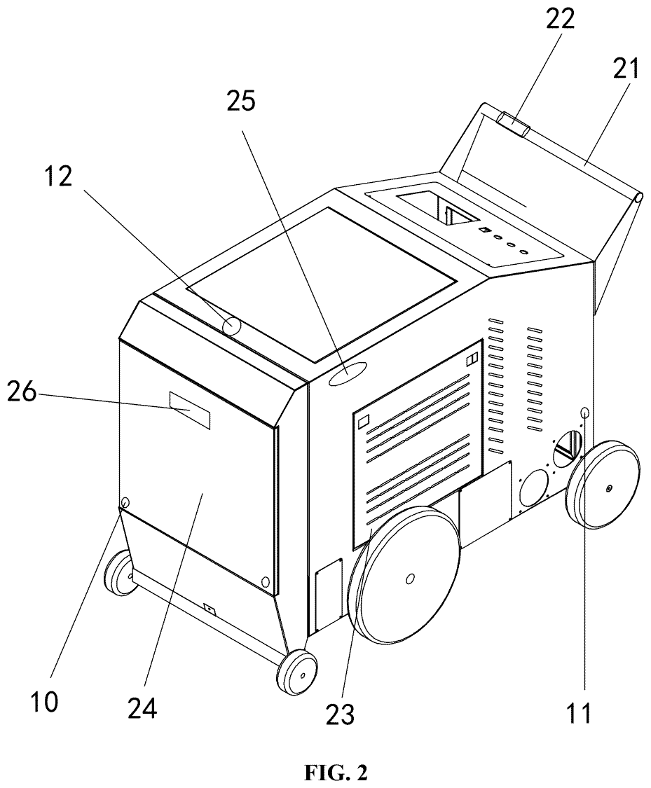

FIG. 3 is a top view of an intelligent laser ground scrubber provided by the embodiment of the present disclosure.

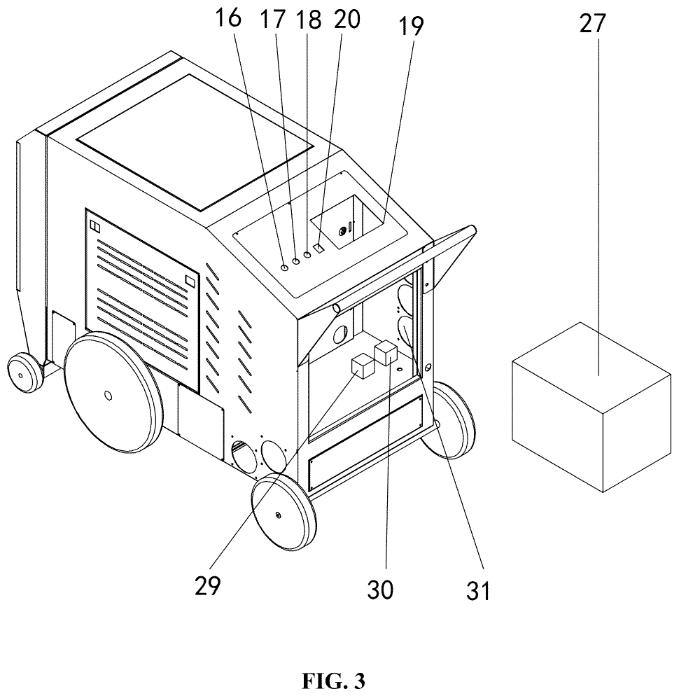

### DETAILED DESCRIPTION OF THE EMBODIMENTS

The following will clearly and completely describe the technical solution in the embodiments of the present disclosure with reference to the accompanying drawings in the embodiments of the present disclosure. Apparently, the described embodiments are merely a part rather than all of the embodiments of the present disclosure. Based on the embodiments in the present disclosure, all other embodiments obtained by those skilled in the art under the premise of without creative labor belong to the scope protected by the present disclosure.

The purpose of the present disclosure is to provide an intelligent laser ground scrubber. Since the intelligent laser ground scrubber is equipped with laser cleaning equipment and an intelligent algorithm control system, the problem of cleaning the dirt which can not be cleaned by conventional mechanical cleaning may be solved, and the deep-layer dirt can be removed from the complex ground, thus improving the cleaning efficiency of the ground, and reducing the cleaning cost of the complex ground.

To make the foregoing purposes, features and advantages of the present disclosure clearer and more comprehensible, the present disclosure is further described in detail below with reference to the accompanying drawings and specific embodiments.

### Embodiment I

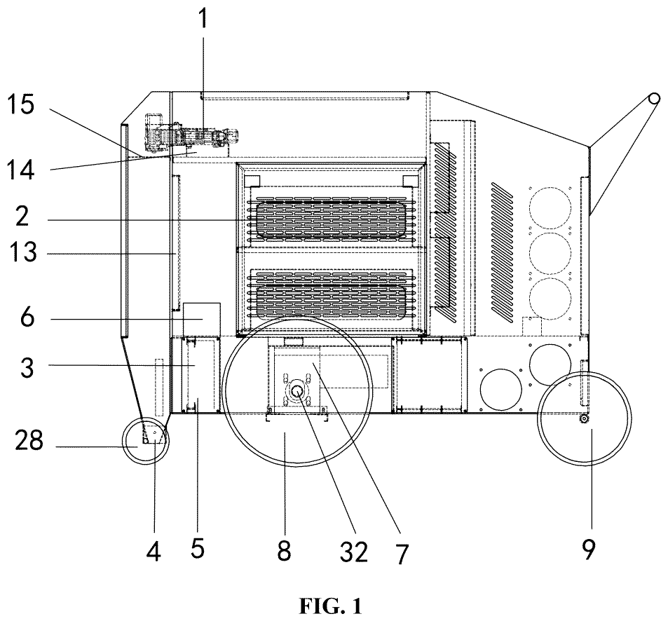

As shown in FIG. 1, the intelligent laser ground scrubber in an embodiment includes the following components.

Besides the intelligent laser ground scrubber includes a high-strength mechanical shell and a bearing frame, main functional structural components of the intelligent laser ground scrubber include the following six parts: a laser cleaning device 100, a dust collection and smoke removal device 200, a walking device 300, a drive controller 6, a visual device with sensor 400, a SLAM intelligent algorithm control system and a power supply 500.

The laser cleaning device 100 is used for cleaning dirt on materials to be cleaned or on ground. The dirt is separated from surfaces of the materials to be cleaned by high-energy laser beams generated by the laser cleaning device.

The laser cleaning device 100 includes a laser generator 2, a mechanical screw, a sliding rail, a cleaning head 1 and a head galvanometer control system.

In an example, the cleaning head 1 can act on the surface of stone to be cleaned by the narrow-pulse-width and high-power-density laser with the energy of 3000 Joules per second, so that the dirt is separated from the surface of a base material to realize surface cleaning under the combined action of mechanisms such as quick light vibration, vaporization, decomposition and plasma peeling.

The intelligent laser ground scrubber includes a laser lens surface anti-dust device, and the laser lens surface anti-dust device is connected with the laser cleaning device 100. The laser lens surface anti-dust device is used for preventing smoke dust particles from adhering to the surface of the lens of the laser cleaning device and preventing the lens from overheating and burning.

The dust collection and smoke removal device 200 is connected with the laser cleaning device 100. The dust collection and smoke removal device 200 is used for discharging cleaned smoke dust impurities to a multistage activated carbon filter screen with an adsorption function along an air flue.

The multistage activated carbon filter screen includes: a first-stage filter screen for filtering large-volume impurities, a second-stage metal filter screen for filtering oily substances, and a third-stage activated carbon filter screen for adsorbing unpleasant odor.

The dust collection and smoke removal device 200 includes an axial flow fan 3, a dust suction port 4 with a wide width of 600 mm, and a three-stage purification filter screen 5.

In an example, the dust collection and smoke removal device 200 can prevent smoke dust particles from adhering to the lens to result in overheating and burning of the lens. The cleaned smoke dust impurities can be discharged to a multistage activated carbon filter screen with an adsorption function along an air flue by means of the axial flow fan 3, thus removing most of the smoke dust after multi-layer filtration.

The SLAM intelligent algorithm control system and the visual device with sensor 400 are arranged on the walking device 300. The SLAM intelligent algorithm control system and the visual device with sensor 400 are used for positioning and mapping, and sending out control signals to drive the walking device 300 to move and avoid obstacles.

The walking device 300 and the drive controller 6 include a drive controller 6, a first brushless motor 7, a second brushless motor, a reduction gearbox, large-sized front drive wheels 8, rear universal wheels 9 and drive wheel clutches 32.

In an example, the first brushless motor 7 has a smooth rate in driving and can support a continuously viable speed regulation. The first brushless motor 7 is better in flexibility by controlling steering. Meanwhile, the drive controller 6 and the laser generator 2 realize same-frequency operation of walking and laser cleaning through a signal interaction.

The visual device with sensor 400 includes an ultrasonic sensor 10, a crash sensor 11 and a visual camera 12.

In an example, the visual device with sensor 400 feeds back signals to the SLAM intelligent algorithm control system by means of conditions around the device, so that the ground scrubber can intelligently clean the ground and effectively avoid obstacles in different environments. The visual camera 12 can capture scene images in the walking process of a machine, and the SLAM algorithm can recognize and extract feature points, such as corner points, edges or other distinguishable visual features, in the images captured by the visual camera 12 in each frame. After the machine finishes capturing the images in the area, the SLAM algorithm compares the similarity of the feature points between the current frame and the previous frame to realize the current position positioning. Meanwhile, the SLAM algorithm determines whether the area needs to be cleaned according to the effect of the current frame image compared with the image of the normal clean ground so as to output a control signal to the driver to drive the walking device to walk or stop cleaning.

In an example, the SLAM intelligent algorithm control system is cooperated with the visual camera 12 to realize positioning and mapping by using the SLAM algorithm, and through system signal processing finally drives the ground scrubber to avoid obstacles and move to cooperate with the laser cleaning head to perform cleaning tasks.

The power supply 500 is connected with the laser cleaning device 100, the dust collection and smoke removal device 200, the walking device 300, the drive controller 6, the visual device with sensor 400 and the SLAM intelligent algorithm control system, respectively. The power supply 500 is used for supplying power for the laser cleaning device 100, the dust collection and smoke removal device 200, the walking device 300, the drive controller 6, the visual device with sensor 400 and the SLAM intelligent algorithm control system.

The power supply modes of the power supply 500 include a wired direct electrification mode, a rechargeable battery mode or a self-power mode.

In an example, the power supply modes of the power supply 500 include a wired direct electrification mode and a self-power mode. In the wired direct electrification mode, the power supply can be directly connected to the equipment for use. In the self-power mode, a small electric generator 27 is arranged at the tail of the equipment. Finally, current is output to a power supply module to solve the problem of power supply in outdoor areas.

The laser cleaning technology adopted in the intelligent laser scrubber is one of core technologies. In the technology, high-energy laser beams are used to irradiate the ground, and stubborn dirt such as stains and oil stains is quickly gasified or decomposed to achieve the deep cleaning. Compared with traditional cleaning methods, laser cleaning has the advantages of high cleaning efficiency, less damage to the ground, and no chemical residues.

### Embodiment II

The integral integrated structure assembly of the intelligent laser ground scrubber is divided into an upper layer, a middle layer, a lower layer and a peripheral visual device with sensor 400.

A dust collection and smoke removal device 200 and a walking device 300 are integrated on the lower layer. A drive controller 6 is fixed at the part of a front beam. A first brushless motor 7 is independently connected to 12.6-inch front drive wheels 8 on the left and right sides in the front part, and rear universal wheels 9 are fixed at the rear part. A plurality of cleaning heads 1 can be selectively mounted in a large space reserved in the middle of the large-sized front drive wheels 8 and the dust collection and smoke removal device 200. Meanwhile, the cleaning heads 1 can also be selectively used for a hand-held cleaning. The cleaning heads 1 are adjusted through a mechanical screw 13 and a sliding rail 14. Walking wheels 28 are connected to the lower part of the mechanical screw 13. During walking, the height of the cleaning head 1 can be freely adjusted according to different conditions of the road surface to ensure that the focal length is in a suitable position. The sliding rail 14 can adjust the distance between the heads for different types of heads to maximize the cleaning width. A partition plate 15 is arranged between the ground and the cleaning head 1, and a gap is reserved in the partition plate 15 to ensure that laser emitted is not hindered. Meanwhile, the contact of the cleaned smoke dust with the lens of the cleaning head 1 is reduced. An air duct is arranged at the oblique rear part of the laser cleaning part. Four axial flow fans 3 are mounted at an air flue outlet. A three-stage purification filter screen 5 is arranged at the rear of the fan. The axial flow fan 3 and the three-stage purification filter screen 5 can be pulled and dismantled through an opening in a side wall of a chassis. Two fans are respectively fixed on both sides of the chassis behind the three-stage purification filter screen 5 and used for exhausting air outward.

A large space is reserved and the partition plate 15 is arranged in the middle layer, and a plurality of cleaning heads 1 are selectively placed on the partition plate 15. The cleaning heads 1 are fixed above the mechanical screw 13 at the front part. The cleaning head 1 is fixed with a U-shaped metal buckle, which conforms to the appearance shape of the hand-held part of the head. A baffle plate above the buckle can be overturned by 180°, so that the head is convenient to disassemble and assemble. A threaded hole is formed in the bottom, so that the cleaning head can be fixed to the reserved position of the mechanical screw 13. Meanwhile, a plurality of cleaning heads 1 can be fixed in the position area in a staggered manner along the front and back directions, so that the cleaning heads 1 can be mounted in a modular manner. The cleaning heads 1 are fixed in the direction that the laser generator 2 emits light beams downward. A light beam output by the cleaning head 1 is in the shape of a wide-width horizontal strip, so that it is ensured that a large area of dirt on the ground can be cleaned during moving. A cooling water tank 30 is filled with purified water. A water source is pumped out from a water outlet of the water tank through a circulating water pump 29 into a circulating pipeline of a cooling fan 31. Finally, the circulating pipeline is connected to a water inlet of the cleaning head 1 through the pipeline. After the head cools down, the water is returned from the water outlet of the cleaning head 1 through the pipeline into the cooling water tank to play the role of circulating cooling of the head.

The upper part is an electrical control integration area where a power supply 500, a laser galvanometer system, a drive controller 6, a dust collection and smoke removal device 200, a visual device with sensor 400, and a SLAM intelligent algorithm control system are integrated. A power line of the power supply 500 is connected to a connecting terminal, and then connected to different electrical components. 24V and 15V transformers and voltage regulator modules are mounted inside the box to meet the power supply needs of equipment with different voltage levels. A power indicator light 16 is assembled above the box. An emergency stop button 17 can cut off a main line of the power supply. The laser generator is controlled through an enable button 18, a control panel 19 operates the program operation of the whole machine, and a forward-reverse button 20 in the manual mode can selectively and independently control walking to reduce the movement inconvenience during personnel use. A handrail 21 is extended upwards out of the rear portion of the upper layer and used to be held by hands during the operation, and a rotatable handle 22 is arranged at the handrail for controlling motor drive in the manual mode.

An ultrasonic sensor 10 and a crash sensor 11 are fixed at the front and rear parts of the periphery of the chassis. In the automatic mode, the ultrasonic sensor 10 can determine the position and distance of obstacles by transmitting and receiving ultrasonic signals so as to help the scrubber to avoid obstacles. When a physical crash occurs, the crash sensor 11 can sense the pressure change and trigger the ground scrubber to adjust the direction. The visual camera 12 is mounted above the directly front of the device, and can generate an accurate environmental map through the SLAM algorithm control system after automatic walking in the area. The equipped camera can not only assist in the construction of indoor and outdoor maps, but also identify ground stains, thus planning and positioning a precise path, and finding and cleaning separately dirty parts of the delimited area in the automatic mode. The sensor transmits real-time data through a hardware sensor interface. The system uses algorithms to make a real-time analysis and decision, and finally drives the movement of the ground scrubber and the execution of the laser cleaning head.

The whole equipment is in an enclosed design. Cover plates 23 on both sides of the chassis are detachable. Meanwhile, an air flue outlet is formed for a connection of laser electrical line to the uppermost control box along a body frame. Meanwhile, the laser beam is surrounded by the box, and the outer part is invisible to ensure the safety of personnel. A laser protection plate 24 is mounted in the oblique front of a panel of the box, so that the cleaning status can be safely observed. Meanwhile, a caution light 25 and an LED illuminating lamp 26 are assembled on the top. During working, the light flashes to remind the safety of the surrounding action personnel, and the application is not affected at night.

The device can be switched between manual and automatic modes. In the manual mode, manual pushing to walk can be selected to clean local areas, and walk can also be driven by the motor to walk for cleaning according to the length of the set walking path. In the automatic mode, the ground scrubber can transmit information through the sensor and camera to automatically map, and an operator can view the location information of the ground scrubber in the map range through a screen. The working range is delimited, and the cleaning time and frequency are set. The ground scrubber can record the planned path after first cleaning to realize automatic cleaning. Meanwhile, the cleaning path is optimized, and the laser parameters are adjusted according to the comparison of a cleaning effect map, and fixed-time and fixed-point cleaning can be performed for dirty areas individually.

The technical features of the above-mentioned embodiments may be arbitrarily combined, and all possible combinations of the technical features in the above-mentioned embodiments are not described for simplicity of description. However, as long as the combinations of the technical features do not contradict, the technical features should be considered to be within the scope of the present disclosure.

Several examples are used for illustration of the principles and implementations of the present disclosure. The description of the above embodiments is used to help illustrate the method and the core principles of the present disclosure; and meanwhile, those skilled in the art can make various modifications in terms of specific embodiments and scope of application in accordance with the teachings of the present disclosure. In conclusion, the contents of this specification should not be understood as a limitation to the present disclosure.

### REFERENCE NUMERALS

100—laser cleaning device;
200—dust collection and smoke removal device;
300—walking device;
400—visual device with sensor;
500—power supply;
1—cleaning head;
2—laser generator;
3—axial flow fan;
4—wide-width dust suction port;
5—three-stage purification filter screen;
6—drive controller;
7—first brushless motor;
8—large-sized front drive wheel;
9—rear universal wheel;
10—ultrasonic sensor;
11—crash sensor;
12—visual camera;
13—mechanical screw;
14—sliding rail;
15—partition plate;
16—power indicator light;
17—emergency stop button;
18—enable button;
19—control panel;
20—forward-reverse button;
21—handrail;
22—rotatable handle;
23—cover plate;
24—laser protection plate;
25—caution light;
26—LED (Light Emitting Diode) illuminating lamp;
27—electric generator;
28—walking wheel;
29—circulating water pump;
30—cooling water tank;
31—cooling fan; and
32—drive wheel clutch.

What is claimed is:

1. An intelligent laser ground scrubber, comprising:
a laser cleaning device, wherein the laser cleaning device is configured for cleaning dirt on materials to be cleaned or on ground, wherein the dirt is separated from surfaces of the materials to be cleaned by high-energy laser beams generated by the laser cleaning device;
a laser lens surface anti-dust device connected with the laser cleaning device, wherein the laser lens surface anti-dust device is configured for preventing smoke dust particles from adhering to a surface of a lens of the laser cleaning device and preventing the lens from overheating and burning;
a dust collection and smoke removal device connected with the laser cleaning device, wherein the dust collection and smoke removal device is configured for discharging cleaned smoke dust impurities to a multistage activated carbon filter screen with an adsorption function along an air flue;
a walking device;
a drive controller;
a visual device with sensor;
a SLAM (Simultaneous Localization and Mapping) intelligent algorithm control system, wherein the SLAM intelligent algorithm control system and the visual device with sensor are arranged on the walking device, wherein the SLAM intelligent algorithm control system and the visual device with sensor are configured for positioning and mapping, and sending out control signals to drive the walking device to move and avoid obstacles; and
a power supply connected with the laser cleaning device, the dust collection and smoke removal device, the walking device, the drive controller, the visual device with sensor, and the SLAM intelligent algorithm control system, respectively, wherein the power supply supplies power for the laser cleaning device, the dust collection and smoke removal device, the walking device, the drive controller, the visual device with sensor, and the SLAM intelligent algorithm control system, respectively,
wherein the laser cleaning device, the laser lens surface anti-dust device, the dust collection and smoke removal device, the drive controller, and the power supply are mounted inside the walking device, and wherein the visual device with sensor is mounted outside the walking device.

2. The intelligent laser ground scrubber according to claim 1, wherein the laser cleaning device comprises a laser generator, a mechanical screw, a sliding rail, a cleaning head and a head galvanometer control system.

3. The intelligent laser ground scrubber according to claim 1, wherein the laser lens surface anti-dust device is connected with a laser lens of the laser cleaning device.

4. The intelligent laser ground scrubber according to claim 1, wherein the dust collection and smoke removal device comprises an axial flow fan, a wide-width dust suction port and a three-stage purification filter screen.

5. The intelligent laser ground scrubber according to claim 1, wherein the walking device and the drive controller comprise a drive controller, a first brushless motor, a second brushless motor, a reduction gearbox, large-sized front drive wheels, rear universal wheels and drive wheel clutches.

6. The intelligent laser ground scrubber according to claim 5, wherein the visual device with sensor comprises an ultrasonic sensor, a crash sensor and a visual camera.

7. The intelligent laser ground scrubber according to claim 6, wherein the SLAM intelligent algorithm control system is connected with the visual device with sensor and the drive controller, respectively.

8. The intelligent laser ground scrubber according to claim 1, wherein power supply modes of the power supply include a wired direct electrification mode, a rechargeable battery mode or a self-power mode.
